(19) United States
(12) Patent Application Publication
(10) Pub. No.: US 2001/0030468 A1
(43) Pub. Date: Oct. 18, 2001

(54) Method and apparatus utilized for priority sequencing

(76) Inventors: George A. Anderson, Columbus, OH (US); Jeremy Margeson, Columbus, OH (US)

Correspondence Address: James R. Eley, Arter & Hadden LLP, One Columbus, 10 West Broad Street, Suite 2100, Columbus, OH, 43215-3422, US

(21) Appl. No.: 09/737,976

(22) Filed: Dec. 15, 2000

Related U.S. Application Data
(60) Provisional application No. 60/171,112, filed on Dec. 16, 1999.

(51) Int. Cl. H02J 1/14

(52) U.S. Cl. 307/31

(57) ABSTRACT

A method and apparatus for priority sequencing a plurality of loads identifies, evaluates, assigns priority values, and couples the plurality of loads to a load managing device. Once connected the loads and load managing device are continuously powered. The load managing device includes a monitoring, detecting, and controlling section, which control the loads based on signals received from the loads and a power supply. When a predetermined condition signal is received by the load managing device the loads are allowed to run based on their assigned priority value, which is determined by the configuration of the system, i.e., in what arrangement the loads are coupled to the load managing device. A higher priority load will run by turning off lower priority loads. Once it has finished, the lower priority loads will turn on in sequence of priority, again based on the arrangement of the loads being coupled to the load managing device.

This application claims priority of Provisional Patent Application, Ser. No. 60/171,112 filed Dec. 16, 1999.

### BACKGROUND OF THE INVENTION

The present invention is related to priority sequencing of electrical loads. More particularly, the present invention is directed to a method and apparatus for priority sequencing of loads that operates based on its unique configuration and without any programmable logic.

It is common to back up power to electrical devices, i.e., loads, that may lose power due to severe weather or other circumstances. Typically, a generator or other power source is connected to the devices for this purpose. To properly deal with loss of power the amount of back up power required must be determined. When that amount is high then a very large, costly, and inefficient power source is usually purchased. Problems can arise when an entity has numerous loads with different power requirements and levels of necessity that must be powered during these circumstances. Also, when calculating a safe amount of power to ensure everything is powered the fact that not everything is powered at once can be overlooked. This problem is overcome by purchasing a smaller power source and constantly manually switching which loads are powered. Although this arrangement saves money, it becomes burdensome since the manual switching has to occur all day and night.

The need for power saving techniques is also needed for certain areas of the world. Some are areas with energy costs determined by the peak power utilized by an entity during a month. Also, some are areas where only alternative power sources can be used for power, i.e., solar, windmill, fuel cells, hydro, engine generator or any other source that is inherently limited in available power. Further, some are areas where the cost of energy changes periodically throughout the day. Finally, some are areas where there is no central power entity, but a distributed power network where each house must supply most of its own power, so that tapping into and using any of a small central power source is prohibitively expensive. Some prior art systems accomplish energy saving through manually rearranging loads. Other use difficult to program and monitor programmable logic array systems. For these situations there is a need for an easy way to best utilize the power available without having to manually monitor all the devices.

In all of these circumstances there are no systems available that allows a user to merely connect all their loads to a load managing device without requiring manual rearrangements and/or programmable logic. Therefore, a system is needed that can priority sequence the loads based on their assigned priority values merely through the coupling configuration.

### SUMMARY OF THE INVENTION

The present invention overcomes all these above-mentioned shortcomings of the prior art. According to the present invention a method and apparatus for priority sequencing a plurality of loads identifies, evaluates, assigns priority values, and couples the plurality of loads to a load managing device. Once connected the loads and load managing device are continuously powered. The load managing device includes a monitoring, detecting, and controlling section, which control the loads based on signals received from the loads and a power supply. In alternative arrangements the monitoring device can be located remotely from the load managing device. When a predetermined condition signal is received by the load managing device the loads are allowed to run based on their assigned priority value, which is determined by the configuration of the system, i.e., in what arrangement the loads are coupled to the load managing device. A higher priority load will run by turning off lower priority loads. Once it has finished, the lower priority loads will turn on in sequence of priority, again based on the arrangement of the loads that are coupled to the load managing device.

A main advantage of the present invention is that no logical arrays are necessary to program, making it a simpler and easier system to use compared to the prior art systems.

Another advantage of the present invention is that the size of a secondary power source or the energy consumption from a central power source is reduced since the priority sequencer more effectively and efficiently manages all the loads of an entity coupled to the load managing device based on a sequence of their priorities.

### BRIEF DESCRIPTION OF THE DRAWINGS

Further features of the present invention will become apparent to those skilled in the art to which the present invention relates from reading the following specification with reference to the accompanying drawings, in which:

FIG. 1 is a diagram of a system according to a preferred embodiment of the present invention;

FIGS. 2A-2D are diagrams of first through fourth stages of operation of the system in FIG. 1 in a preferred embodiment of the present invention;

FIG. 3 is a flow chart of a operation method according to a preferred embodiment of the present invention;

FIG. 4 is a flow chart of a determining and assigning sub-operation in the method of FIG. 3;

FIG. 5 is a flow chart of monitoring, detecting, and controlling sub-operations in the method of FIG. 3; and

FIG. 6 is a flow chart of a determining sub-operation within the controlling sub-operation in the method of FIGS. 3 and 5.

### DESCRIPTION OF THE PREFERRED EMBODIMENT(S)

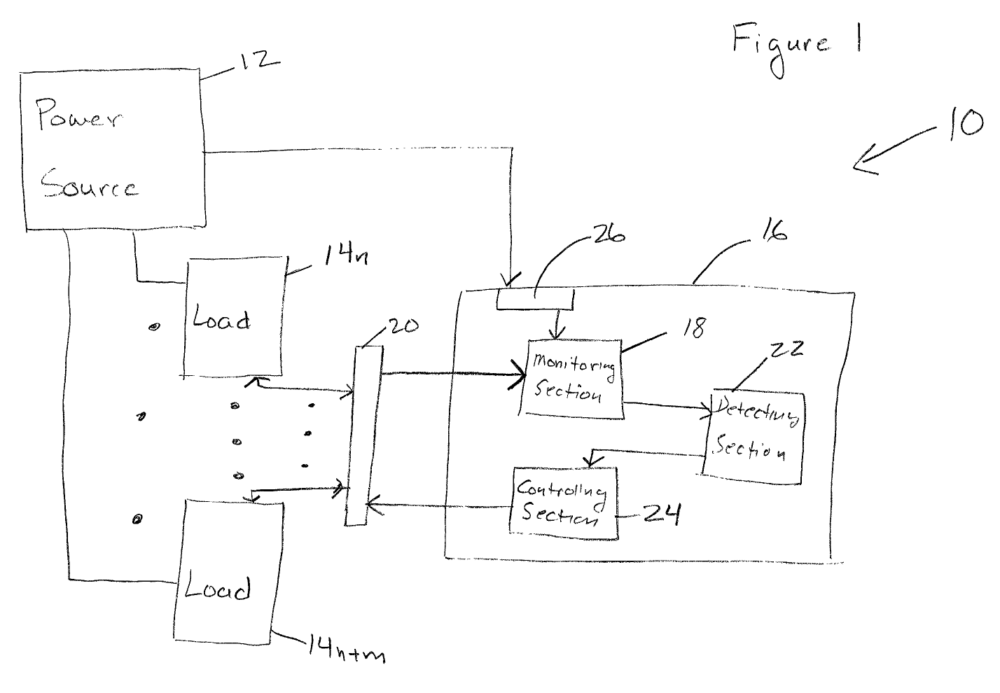

With reference to FIG. 1, a system 10 according to a preferred embodiment of the present invention is shown. The system includes a power source 12 that powers loads 14ₙ-14ₙ₊ₘ, (hereinafter “14” unless otherwise discussed), where n and m are positive integers, and a load managing device 16 at all times. The loads 14 are coupled to a monitoring section 18 in the load managing device 16 via a coupling section 20. In other preferred embodiments of the present invention, a preferred configuration has the loads 14 being remotely monitored by a remote monitoring section (not shown). A detecting section 22 and controlling section 24 are also located within the load managing device 16. The power source 12 is also coupled to the monitoring section 18 via a coupling device 26. In some alternative configurations the power source 12 can include a primary and secondary power source.

The load managing device 16 is preferably a Sequent Power, Inc. PRIORITIZER® Alternative Power Source AE Series device, a Sequent Power, Inc. PRIORITIZER® Backup Gensets with Transfer Switch ECS Series device, a Sequent Power, Inc. PRIORIRIZER® Peak Demand Reduction NC Series device, or similar functioning device. The load managing device 16 preferably is in continuous operation when it is utilized for alternative power or peak power shaving environments. On the other hand, when there is no alternative power or peak power shaving environment detected the load managing device 16 preferably is in a non-sequencing mode when a primary section of the power source 12 is detected and in a sequencing mode when a secondary section of the power source 12 is detected.

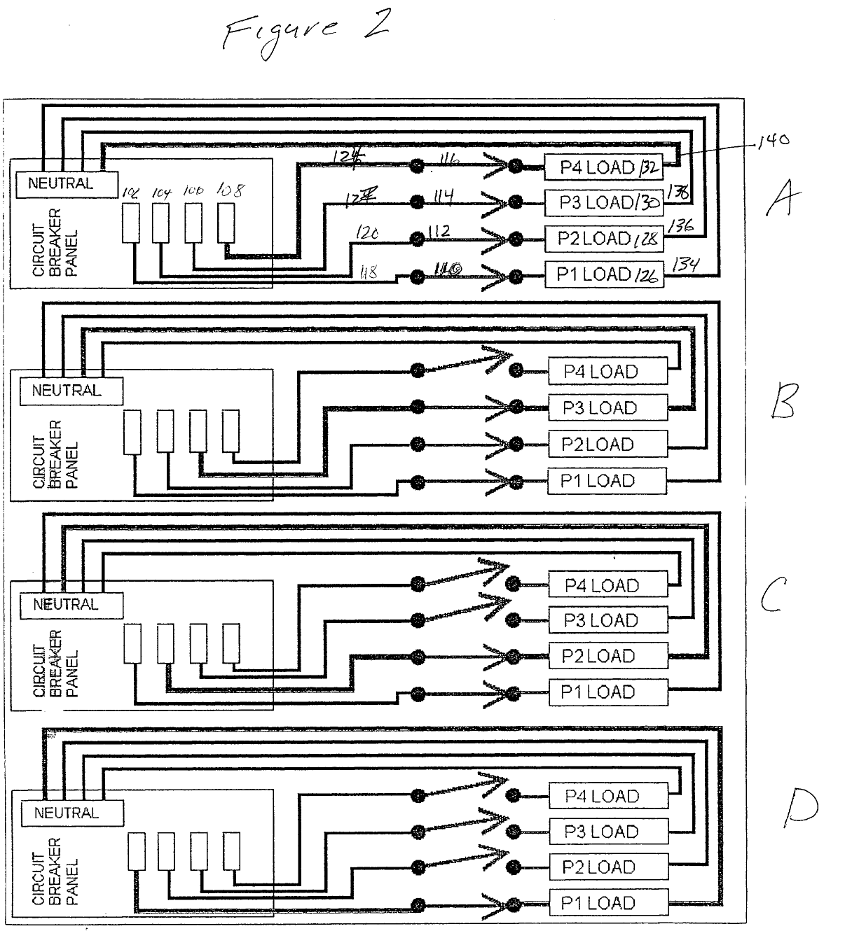

The coupling section 20 is preferably in a circuit breaker box, a junction box, a terminal box, or the like when the monitoring is not being performed remotely. The coupling section 20 preferably has current sensors in series with solid-state relay switches in series with a load connection section (see FIG. 2). On the other hand, when the monitoring is being done remotely, then the coupling section 20 preferably includes part of the monitoring section, e.g., a current sensor, and is located proximate a device being monitored.

The loads 14 are assigned a priority value based on their operating characteristics. For example, if the loads 14 were identified in an identifying step to be: (1) a pump—it would be determined to have a short duty cycle and it would be assigned a high priority value; (2) a refrigeration unit—it would be determine to be an element within the system 10 that should remain on as much as possible, i.e., a necessary element, and it would be assigned a high priority value; (3) a hot water heater—it would be determined to have a long duty cycle and it would be assigned a low priority value; or (4) an air conditioning unit—it would be determined to be an element within the system 10 that does not have to be on except for convenience and it would be assigned a low priority value. Care should be taken to prevent the total the duty cycles of all loads attached to any given load managing device 16 from exceeding 100%. Otherwise, the load having the lowest assigned priority will not be allotted enough duty cycle to function properly, In this event, an additional load managing device 16 should be employed. Of course, these are just a few examples, but the normal determining of characteristics and assigning steps would prioritize short duty cycle and necessary elements and de-prioritize long duty cycle and unnecessary or convenience elements.

After a range of priority values have been assigned to the loads 14, they are coupled in relative priority value order to the coupling section 20. Following the coupling, the loads 14 and load managing device 16 are powered by the power source 12 and will remain continuously powered. The monitoring section 18 is configured to receive signals from the coupling device 20 corresponding to conditions of the load and signals from coupling device 26 corresponding to conditions of the power source 12. The detecting section 22 is configured to receive signals from the monitoring section 18 corresponding to the conditions of the loads 14 and power source 12. Based on the signal received by the detecting section 22 a signal is transmitted to the controlling section 24. Based on the signal received by the controlling section 24 one or more of the loads 14 are turned OFF and ON, i.e., are allowed to run or prohibited from running, but power is always transmitted to the loads.

During certain situations or circumstances, e.g., daily periodic raise in energy rates, over/under voltage, over/under current, loss of power, low power, or the like, a predetermined condition signal is sent from the power source 12. The predetermined condition signal is a signal generated by the power source 12 or loads 14 correlating to one or more of the events just described. This predetermined condition signal is transmitted to the controlling section 24 via the monitoring section 18 and the detecting section 22. The controlling section 24 then transmits a corresponding predetermined condition signal to the coupler 20. This predetermined condition signal from the controlling section 24 initiates, adjusts, or allows to continue a priority sequencing operation 200, described in more detail below. The operation 200 initiates a priority sequencing operation circuit arrangement corresponding to what type of predetermined condition signal was received by the controller 24. Once the detector 22 determines the power source 12 has ceased its transmission of the predetermined condition signal the controller 24 transmits a corresponding signal for that occurrence to the coupler 20. The coupler 20 then configures the system 10 into a normal priority sequencing operation for the particular environment, i.e., alternative power source, peak power shaving, or backup power.

Turning to FIGS. 2A-2D, are arrangements of the system 10 for four different signals received by the coupler 20 is shown according to a preferred embodiment of the present invention. It is to be appreciated that there are various configurations of the system 10 based on a number of the loads 14 that are attached to the system and what circumstances are prevalent at any given time. Only FIG. 2A is being labeled for ease of viewing the elements within FIGS. 2A-2D. In these figures a preferred coupler 20 includes input sections 102, 104, 106, and 108 corresponding to a priority 1 through 4 load, respectively. These input sections 102-108 are connected to switching devices 110, 112, 114, and 116, respectively, via a first set of connecting devices 118, 120, 122, and 124, respectively. Preferably, the switching devices 110-116 are solid-state relay switches. The switching devices 110-116 open and close a circuit proximate sensing devices 126, 128, 130, and 132, respectively. Preferably, the sensing devices 126-132 are current sensors. Finally, a circuit is completed through a second set of connecting devices 134, 136, 138, and 140. Preferably, the first and second set of connecting devices 110-116 and 118-124, respectively, are electronic signal transmission lines, e.g., wires.

The system 10 operates by always providing power to the highest priority load 14 that starts drawing current by automatically switching off lower priority loads 14, whether one of them is drawing current or not. The load arbitration is very fast, preferably between 16 to 33 milliseconds (1-2 AC cycles) to effect a higher priority load to turning off a lower priority load. This allows for maximum available starting amperage and provides a five second dead time before lower priority loads are restored (re-energized), this eliminates false starts due to contact bounce, which may be present in some loads, such as an appliance controller.

With continuing reference to FIG. 2A, only a lowest priority load 14-4 is drawing current, i.e., turned ON or running, as is indicated by thickened lines for connecting devices 124 and 140. Hence, although all the switches 110-116 are closed, only one of the loads 14-4, priority four, is operating, i.e., drawing current, while all the loads 14-1 through 14-4 have voltage across them. Turning to FIG. 2B, when a priority 3 load 14-3 is detected by current sensor 132 as beginning to draw current, i.e., the load turns ON or runs, then the switch 116 moves into an open position, turning OFF the priority 4 load 14-4. As can be seen in FIGS. 2C and 2D, the same operation occurs when the priority 2 load 14-2 and priority 1 load 14-1, respectively, are detected by current sensor 128 or 130, respectively, as starting to draw current, i.e., the loads 14-1 and/or 14-2 turn ON. Thus, since the load managing device 16 controls the amount of power being consumed by the loads in this manner less power is drawn from the power source 12, while ensuring that at no time does a high priority load 14 not operate.

In the alternative preferred embodiment when the coupling device 20 is used for a remote device it would include a current sensing device and a section that would be coupled to a section of the remote device. Therefore, through this configuration, the coupling device 20 would be used to monitor and control the remote device to initiate, adjust, or continue a priority sequencing operation. In the alternative, the switching function could be performed by a definite purpose contactor instead of a solid state relay.

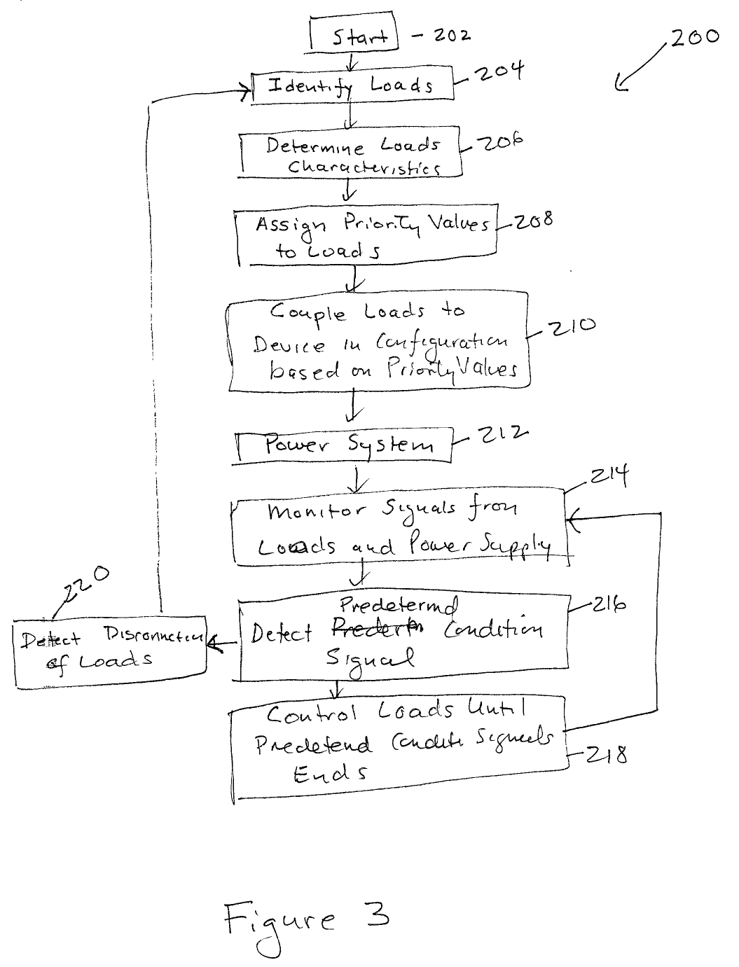

An operation 200 of the system 10 according to a preferred embodiment of the present invention is shown in FIGS. 3-6. In FIG. 3, the operation 200 is shown in detail. After starting at step 202, all loads 14 are identified at step 204. Once the loads 14 are all identified, their characteristics are determined at step 206. From this determination step 206, an assignment of priority values for each load 14 is performed at step 208. Based on these assigned priority values the loads 14 are coupled to the coupler 20 in a predetermined configuration at step 210. Power is then transmitted to the system 16 from the power source at step 212. Monitoring will begin once the system is powered at step 214. During the monitoring operation the loads 14 and power source 12 send signals to the monitoring section 18.

In one preferred embodiment of the present invention, a certain type of power source 12, e.g., alternative power or peak power shaving, or state of the power source 12, i.e., loss of primary power, over/under voltage/current, etc., generates a predetermined condition signal that is transmitted to detecting section 22 via the monitoring section 18. This detection of a predetermined condition signal is performed at step 216. A corresponding predetermined condition signal is sent to the controlling section 24 at step 218. The controlling section 24 then controls the loads 14 in response to receiving the predetermined condition signal from the detecting section 22 at step 218. The controlling section 24 continues the controlling until the monitoring section 22 transmits to the controlling section 24 a signal indicating that the predetermined condition signal has ended. At that time the monitoring step 214 resumes in a pre-predetermined condition signal mode.

In another preferred embodiment of the present invention, the loads 14 are monitored to determine if they are operating, i.e., drawing current, or not or if the load were disconnected and a different load 14 is connected in its place. In this situation the detecting step 216 would result in a predetermined condition signal being sent to the controlling section 24 corresponding to this condition. The controlling section 24 would be monitoring for a disconnection load signal at step 220, which would result in the repetition of steps 204-218 again.

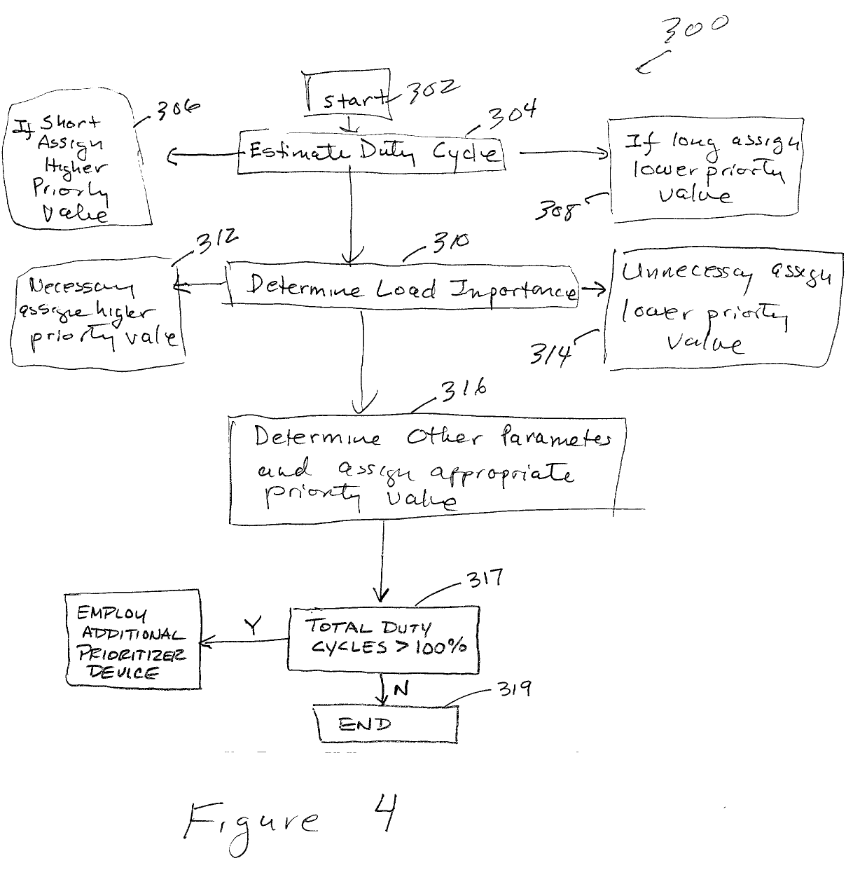

With reference to FIG. 4, the identifying 204, determining characteristics 206, and assigning priority values 208 steps sub-operations 300 are shown in more detail. After starting at step 302, a duty cycle of each of the loads is estimated or determined at 304. If the estimated duty cycle is short, then the load 14 is assigned a higher priority value at 306. On the other hand, if the estimated duty cycle is long, then the load 14 is assigned a lower priority value at 308. Next, the relative importance of the load 14 is determined at step 310. If the determined importance is that the load 14 must remain operating as much as possible, then the load 14 is assigned a higher priority value at 312. On the other hand, if the determined importance is that the load 14 does not have to operate, i.e., it is a convenience item, then the load 14 is assigned a lower priority value at 314. The same operation would continue for all other suitable parameters that can be determined to assign higher or lower priority values to the loads at 316. The total duty cycles of all loads attached to a given load managing device is determined at 317. If the cumulative duty cycles exceed 100%, an additional load managing device is employed at 318. Once all the loads have been assigned priority values and it is determined that the cumulative duty cycles is less than 100% for a given load managing device, this operation ends at 319.

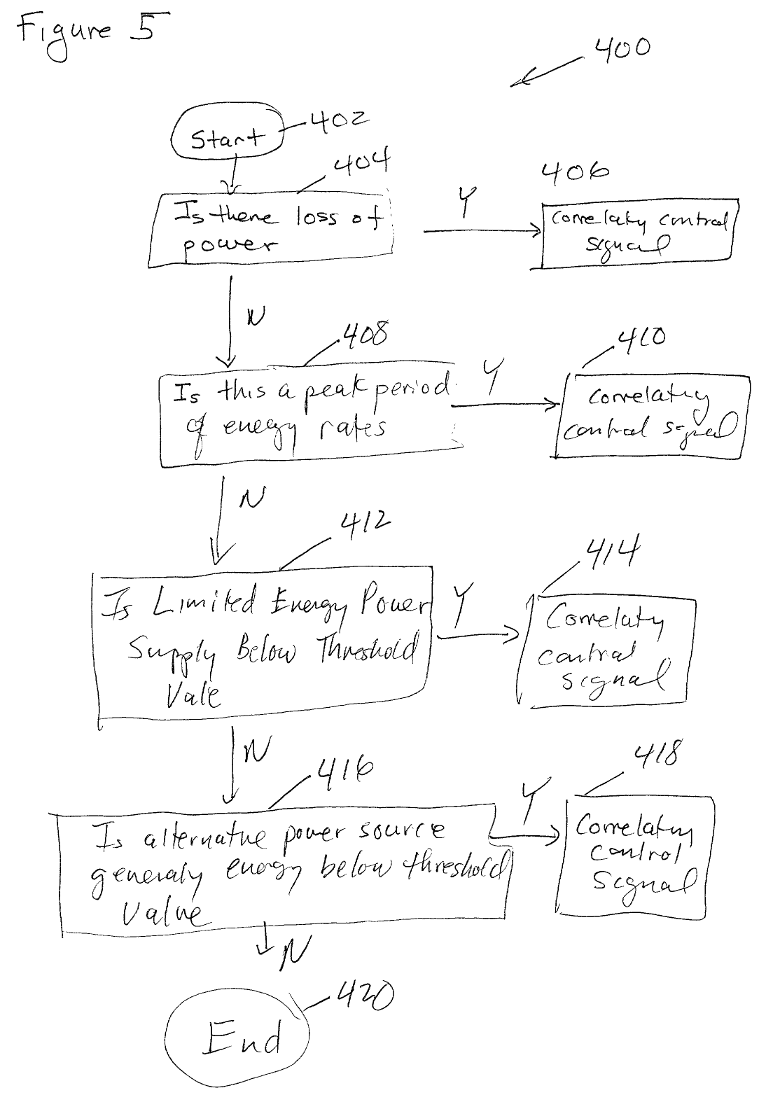

Turing now to FIG. 5, a sub-operation 400 of the detecting step 216 is shown. After the operation 400 starts at 402, a determination is made whether the predetermined condition signal corresponds to a loss of power of a primary section of the power source 12 at 404. If so, the predetermined condition signal correlating to this occurrence is transmitted to the controlling section 24 at 406. Otherwise, the operation 400 determines whether a peak period of energy rates is about to begin and peak shaving should be done at 408. If so, the predetermined condition signal correlating to this occurrence is transmitted to the controlling section 24 at 408. Otherwise, the operation 400 determines if a limited energy power supply is getting low at 410. If so, the predetermined condition signal correlating to this occurrence is transmitted to the controlling section 24 at 412. Otherwise, the operation 400 determines if an alternative power source is connected and/or if the alternative power supply is generating a lower amount of energy than a predetermined threshold value at 414. If so, the predetermined condition signal correlating to this occurrence is transmitted to the controlling section 24 at 416. Although not explicitly shown here, other occurrences which result in a predetermined condition signal being generated by the power source 12 or loads 14 can be evaluated by the operation 400 and a correlating predetermined condition signal can be sent from the detecting section 22 to the controlling section 24 at 418. Once all the possible predetermined conditions have been evaluated, the operation 400 ends at 420.

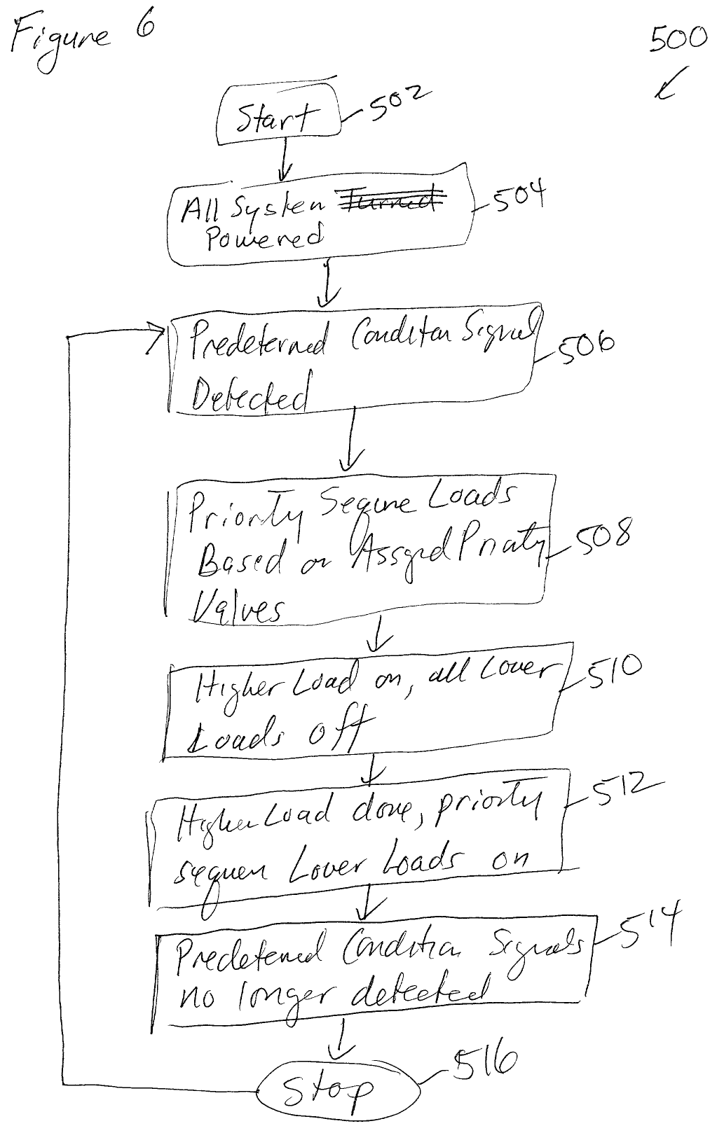

With reference to FIG. 6, a sub-operation 500 within the controlling step 218 is shown. After starting at step 502, all loads 14 are powered, but not necessarily turned on to run, at step 504. When a predetermined condition signal is received by the controlling section 24 a signal is sent to the coupler 20 at 506 indicating a predetermine condition state is presently occurring. As described above, this predetermined condition can be that an alternative power source is being used, that a peak shaving situation is occurring, that a primary power source has lost power, or any other situation where a priority sequencer can be utilized.

With continuing reference to FIG. 6, during a priority sequencing operation, the coupler 20, based on the controlling section 24, will perform priority sequencing to control when the loads 14 are allowed to be ON and OFF, i.e., allowing them to draw current or forming an open circuit, at step 508. In operation, if a higher priority load 14 begins to draw current, i.e., turns ON to run, all lower priority loads will turn off at 510, preferably by opening a switch. Once the higher priority load 14 receives a predetermined amount of energy or the higher priority load's parameters are above/below a certain threshold value allowing it to go into an OFF state, the lower priority loads 14 can again turn ON, i.e., draw current, in their assigned sequence of priorities at step 512. This priority sequencing continues until step 514, which is when the operation 500 determines the predetermined condition signal is no longer being received by the controlling section 24. At step 516 the priority sequencing stops until another predetermined condition signal is detected. Usually, this last step would be more frequently utilized with a primary/secondary power source environment detecting for loss of primary power.

Thus, during the operation 200 whenever a higher priority load 14 needs to run, it can temporarily turn off the lower priority loads 14, and when the higher priority load is finished, the lower priority loads 14 will once again receive power in sequence to allow them to run. This is done without requiring programmable logical arrays making it simper to use than most prior art systems. Through this system 10 and operation 200, a lower amount of power is needed to run the same amount of loads, which reduces the energy consumption and costs associate with an entity maintaining its operations.

From the above description of the invention, those of skill in the art will perceive improvement, changes, and modifications in the invention. Such improvement, changes, and modifications are intended to be covered by the appended claims.

I/we claim:

1. A method comprising the steps of:
identifying loads to be coupled to a system;
determining characteristics of the identified loads;
assigning a range of priority values from a highest priority to a lowest priority of the identified loads corresponding to the determined characteristics;
coupling the identified loads to the system based on the determined priority;
powering the system and the loads with a power source;
monitoring signals from the loads and power source;
detecting predetermined condition signal from the power source or one or more of the loads; and
controlling the loads via the system in response to the detecting of the predetermined condition signal until the predetermined condition signal ends.

2. The method of claim 1, wherein the determining characteristics further comprising the step of determining a duty cycle of the load.

3. The method of claim 2, wherein the assigning further comprises the steps of:
assigning a higher priority value when the determined duty cycle is lower than a threshold value; and
assigning a lower priority value when the determined duty cycle is higher than a threshold value.

4. The method of claim 1, wherein the determining characteristics further comprises the step of determining a importance value of the load.

5. The method of claim 4, wherein the assigning further comprises the steps of:
assigning a higher priority value when the determined importance value is lower than a threshold value; and
assigning a lower priority value when the determined importance value is higher than a threshold value.

6. The method of claim 1, wherein the determining characteristics further comprises the step of determining a parameter value of the load.

7. The method of claim 6, wherein the assigning further comprises the steps of:
assigning a higher priority value when the determined parameter value is lower than a threshold value; and
assigning a lower priority value when the determined parameter value is higher than a threshold value.

8. The method of claim 6, wherein the assigning further comprises the steps of:
assigning a higher priority value when the determined parameter value is higher than a threshold value; and
assigning a lower priority value when the determined parameter value is lower than a threshold value.

9. The method of claim 1, wherein the detected predetermined condition is loss of power.

10. The method of claim 1, wherein the controlling further comprises the steps of:
determining a lowest of the assigned priority value of the detected predetermined condition signal from the one or more loads;
stopping operation of the loads having the assigned priority value below the lowest of the assigned priority values of the detected predetermined condition signal, while continuing to power all the loads; and
starting operation of the loads having the assigned priority value below the lowest of the assigned priority values of the detected predetermined condition signal when the predetermined condition signal ends.

11. A system comprising:
means for identifying loads to be coupled to a load managing device;
means for determining characteristics of the identified loads;
means for assigning a range of priority values from a highest priority to a lowest priority of the identified loads corresponding to the determined characteristics;
means for coupling the identified loads to the load managing device based on the determined priority;
means for powering the load managing device and the loads with a power source;
means for monitoring the loads and power source;
means for detecting predetermined condition signal from the power source or one or more of the loads; and
means for controlling the loads via the load managing device in response to the detecting of the predetermined condition signal until the predetermined condition signal ends.

12. The system of claim 11, wherein the means for determining characteristics further comprises a means for determining a duty cycle of the load.

13. The system of claim 12, wherein the means for assigning further comprises:
means for assigning a higher priority value when the determined duty cycle is lower than a threshold value; and
means for assigning a lower priority value when the determined duty cycle is higher than a threshold value.

14. The system of claim 11, wherein the means for determining characteristics further comprises a means for determining a importance value of the load.

15. The system of claim 14, wherein the means for assigning further comprises:
means for assigning a higher priority value when the determined importance value is lower than a threshold value; and
means for assigning a lower priority value when the determined importance value is higher than a threshold value.

16. The system of claim 11, wherein the means for determining characteristics further comprises means for determining a parameter value of the load.

17. The system, of claim 16, wherein the means for assigning further comprises:
means for assigning a higher priority value when the determined parameter value is lower than a threshold value; and
means for assigning a lower priority value when the determined parameter value is higher than a threshold value.

18. The system of claim 16, wherein the means for assigning further comprises:
assigning a higher priority value when the determined parameter value is higher than a threshold value; and
assigning a lower priority value when the determined parameter value is lower than a threshold value.

19. The system of claim 11, wherein the detected predetermined condition is [see claim 9] (loss of power; a peak shaving signal; low power supply energy; type of power supply energy)

20. The system of claim 11, wherein the means for controlling further comprises:
means for determining a lowest of the assigned priority value of the detected predetermined condition signal from the one or more loads;
means for stopping operation of the loads having the assigned priority value below the lowest of the assigned priority values of the detected predetermined condition signal, while continuing to power all the loads; and
means for starting operation of the loads having the assigned priority value below the lowest of the assigned priority values of the detected predetermine condition signal when the predetermined condition signal ends.
